(19) United States
(12) Patent Application Publication
(10) Pub. No.: US 2025/0176485 A1
(43) Pub. Date: Jun. 5, 2025

(54) MECHANICALLY AUTOMATED IRRIGATION DEVICE

(71) Applicant: Byron TURNER, Cottage Grove, OR (US)

(72) Inventor: Byron TURNER, Cottage Grove, OR (US)

(21) Appl. No.: 18/525,675

(22) Filed: Nov. 30, 2023

(51) Int. Cl. A01G 25/16

(52) U.S. Cl. CPC A01G 25/165

(57) ABSTRACT

Typically, non-automated irrigation systems demand manual labor for operation, making them labor-intensive and physically demanding, especially in gardening and small farming operations. On the other hand, automated electrical energy-requiring irrigation systems may require to operate in remote locations, such as small crop field locations, where no supporting infrastructure exists. Disclosed embodiments eliminate or reduce the dependence of manual labor and automatize the irrigation process through a mechanically automated irrigation device, which is capable is working solely with mechanical energy and gravity.

### TECHNICAL FIELD

The embodiments described herein are generally directed to an irrigation device in small farming operations and gardening contexts, and, more particularly, to devices and systems for mechanically automated irrigation.

### BACKGROUND

Non-automated irrigation systems pose several challenges. These systems often demand manual labor for operation, making them labor-intensive and physically demanding, especially in gardening and small farming operations. The lack of automation can lead to inefficient water use, as precise control and real-time adjustments are difficult. Inconsistent irrigation patterns, human errors, and potential over-or under-irrigation can result in uneven moisture levels, which can lead to reduced production, plant damage or plant loss.

On the other hand, automated electrical energy-requiring irrigation systems, while offering numerous advantages, also come with their own set of challenges. Electrically automated irrigation systems can be costly to install and maintain due to the need for sophisticated technology, sensors, and controls. Breakdowns or malfunctions in these systems can be complex to diagnose and repair. Battery powered timers are less expensive, but battery levels must be monitored and batteries replaced or repaired. Even a brief period of inattention can lead to a significant plant loss. Finally, most battery-powered water timers require a pressurized liquid source.

Accordingly, a mechanically automated irrigation device, which works solely with mechanical energy and gravity, would offer a variety of benefits such as set and forget, powerless functionality, inexpensive set up, and adaptability with other systems. The present disclosure is directed toward overcoming one or more of the problems discovered by the inventor.

### SUMMARY

In an embodiment, a mechanically automated irrigation device comprises: an inlet flow; at least an outlet flow located downstream from the inlet flow; a transfer volume located intermediate the inlet flow and the outlet flow; and a floating valve system coupled to the inlet flow and the outlet flow, the floating valve system having a liquid container designed to facilitate evaporation, an internal flow duct extending from the inlet flow to the outlet flow, wherein the internal flow duct is positioned at least partially in the transfer volume, a floating valve duct, wherein the floating valve duct intersects the internal flow duct to form a junction of the top of the floating valve duct and the internal flow duct, a floating valve positioned within the floating valve duct, wherein the floating valve is configured to move vertically within the floating valve duct in response to a volume level in the liquid container, wherein the floating valve is configured to block the transfer volume when positioned at the junction of the internal flow duct and the floating valve duct, and a feedback array connected to a downstream portion of the internal flow duct, wherein the feedback array is configured to feed liquid to the liquid container.

In an embodiment, an irrigation system comprises: a liquid source; a mechanically automated irrigation device, comprising: an inlet flow; at least an outlet flow located downstream from the inlet flow; a transfer volume located intermediate the inlet flow and the outlet flow; and a floating valve system coupled to the inlet flow and outlet flow, the floating valve system having a liquid container designed to facilitate evaporation, an internal flow duct extending from the inlet flow to the outlet flow, wherein the internal flow duct is positioned at least partially in the transfer volume, a floating valve duct, wherein the floating valve duct intersects the internal flow duct to form a junction of the top of the floating valve duct and the internal flow duct, a floating valve positioned within the floating valve duct, wherein the floating valve is configured to move vertically within the floating valve duct in response to a volume level in the liquid container, wherein the floating valve is configured to block the transfer volume when positioned at the junction of the internal flow duct and the floating valve duct, a feedback array connected to a downstream portion of the internal flow duct, wherein the feedback array is configured to feed liquid to the liquid container; and an irrigation distributor.

In an embodiment, a method for automatically irrigating with a mechanically automated irrigation device, the method comprises: routing an inlet flow to an outlet flow located downstream; transferring volume located intermediate the inlet flow and the outlet flow; and coupling a floating valve system between the inlet flow and outlet flow, the floating valve system having a liquid container designed to facilitate evaporation, an internal flow duct extending from the inlet flow to the outlet flow, wherein the internal flow duct is positioned at least partially in the transfer volume, a floating valve duct, wherein the floating valve duct intersects the internal flow duct to form a junction of the top of the floating valve duct and the internal flow duct, a floating valve positioned within the floating valve duct, wherein the floating valve is configured to move vertically within the floating valve duct in response to a volume level in the liquid container, wherein the floating valve is configured to block the transfer volume when positioned at the junction of the internal flow duct and the floating valve duct, and feeding liquid to the liquid container through a feedback array connected to a downstream portion of the internal flow duct.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates an irrigation system with a mechanically automated irrigation device, according to an embodiment;

FIG. 2A illustrates a mechanically automated irrigation device in an open position, according to an embodiment;

FIG. 2B illustrates a mechanically automated irrigation device in a closed position, according to an embodiment;

FIG. 3 illustrates a feedback array, according to an embodiment; and

FIG. 4 illustrates a mechanically automatic irrigation process; according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description. In addition, it should be understood that the various components illustrated herein are not necessarily drawn to scale. In other words, the features disclosed in various embodiments may be implemented using different relative dimensions within and between components than those illustrated in the drawings.

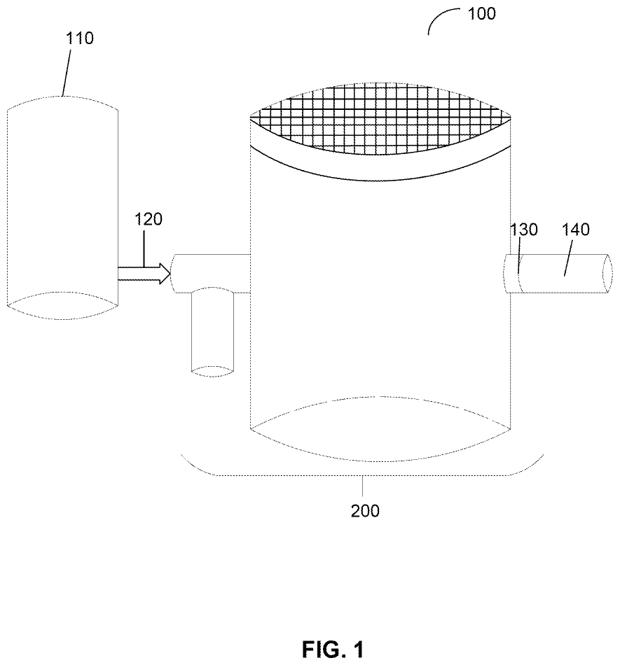

FIG. 1 illustrates an irrigation system 100 with a mechanically automated irrigation device 200, according to an embodiment. Irrigation system 100 includes a liquid source 110, which can include water or mix of water with irrigation nutrients, a mechanically automated irrigation device 200 with an inlet flow 120 and an outlet flow 130, and an irrigation distribution system 140. Although only one or two of each component is illustrated, it should be understood that irrigation system 100 may comprise any number of each component, including a plurality of one or more components. Irrigation system 100 may be connected to or integrated into mechanically automated irrigation device 200, which controls (e.g., allows water to flow) the passage of liquid from inlet flow 120 to outlet flow 130 into irrigation distribution system 140.

Liquid source 110 of irrigation system 100 can be configured to store liquid which can include water or mix of water with irrigation nutrients. Liquid source 110 can be configured to supply water entering mechanically automated irrigation device 200 through inlet flow 120, and may include one or multiple streams of liquid. For example, liquid source 110 may include typically a reservoir, river, or well, integrated into irrigation system 100. Liquid source 110 may serve as the starting point for the controlled distribution of liquid (e.g. water) to home gardeners, community gardens, animal water reservoirs, small family farm operations or landscape areas. Liquid source 110 supply can be accomplished through either gravity-based or pressure-based systems. Gravity-based systems harness the natural force of gravity to transport liquid from an elevated source to a lower point of use, with liquid flowing downhill. In contrast, liquid source 110 may come from a pressure-based systems that utilizes mechanical pumps or pressure tanks to pressurize and deliver liquid, regardless of elevation differences. Irrigation system 100 may be adapted to either gravity-based or pressure-based systems

Inlet flow 120 receives liquid from liquid source 110 and can be located upstream from at least an outlet flow 130. Liquid entering inlet flow 120 and connecting to mechanically automated irrigation device 200 can involve a seamless process of volume transfer of a liquid to outlet flow 130. Inlet flow 120 can be configured with mechanisms to regulate water flow rates, ensuring precise and efficient delivery to designated irrigation channels or pipelines. Further, from inlet flow 120, the liquid can be guided through a network of pipes or conduits, leading it to mechanically automated irrigation device 200.

Mechanically automated irrigation device 200 receives liquid through inlet flow 120. Mechanically automated irrigation device 200 is designed to optimize the watering of plants, crops, or landscapes mitigating the need of an electrical energy source because it functions mechanically through measuring the rate of evaporation of liquid (water). Mechanically automated irrigation device 200 comprises a network of components mechanically connected and dependent on the environmental evaporation factors such as temperature, humidity, wind, and solar radiation. The functionality of mechanically automated irrigation device 200 involves regulating the delivery of liquid based on preset parameters, such as time, duration, and frequency through evaporation. Additionally, mechanically automated irrigation device 200 may control irrigation in response to environmental and local conditions, like rainfall or soil moisture levels. Mechanically automated irrigation device 200 automation minimizes water wastage, promotes healthier plant growth, and conserves resources, making it an environmentally responsible solution for maintaining lush and thriving green spaces. Mechanically automated irrigation device 200 may be portable, removable and/or replaceable.

Further, liquid exits mechanically automated irrigation device 200 through outlet flow 130 and can be located downstream from inlet flow 120. Liquid exiting outlet flow 130 and connecting to irrigation distribution system 140 can involve a seamless process of volume transfer. Outlet flow 130 can be configured with mechanisms to regulate water flow rates, ensuring precise and efficient delivery to designated irrigation channels or pipelines of irrigation distribution system 140. Further, from outlet flow 130, the liquid can be guided through a network of pipes or conduits, leading it to irrigation distribution system 140.

Finally, irrigation system 100 include irrigation distribution system 140. Irrigation distribution system 140 serves as the circulatory system for delivering water to fields, crops, or landscapes in an organized and efficient manner. Irrigation distribution system 140 infrastructure may comprise a network of pipes, valves, pumps, and distribution channels. Irrigation distribution system 140 functionality is to transport water from outlet flow 130 to the desired location and to regulate the flow to ensure precise and controlled irrigation. Pipes and pipelines carry water over various distances, while valves and pumps manage water pressure and flow rates in irrigation distribution system 140. The distribution channels may be equipped with sprinklers or drip emitters, disperse water evenly across the designated area. Further, irrigation distribution system 140 may include a control knob with a system main tube where flow arrays can be placed at 1, 3, 5, 7 and 9 feet along the main tube to allow users to place emitter arrays, appropriate to their needs, and maintain neat rows with correct spacing. Further, distribution system 140 may comprise a modular potting system with a an internal watering system as well as decorative water features. The modular potting system can be placed on the ground and daisy chained with distribution system 140 or a standard garden hose or drip tubing. The modular potting system can serve gardens with limited space and vertical designs by proving pots that allow them to plant in the top, sides and bottom of the pot and moisture is maintained with an internal distribution system 140. The modular potting system can connect directly to irrigation system 100 system and to each other proving a single, automated watering system that provides set and forget ease and the assurance that their plants maintain the right amount of moisture regardless climatic conditions. The modular potting system is a unique addition to the home gardening space. Seeds are started in 2.5 inch×3 inch stainless steel cylinders and when the plants are mature enough, a top iris control lever can be adjusted to secure the plants. Then a seed starter/planter insert can be inserted into a plant node and the locking ring is turned clockwise to secure the seed starter/planter insert in place. For aesthetic reasons, the modular potting system can be watered through ¼ drip line which can be hidden behind hanger support cables. The drip main line can be attached to whatever structure the pot hangs from, thus a single water source can be used to water as many pots as the user wants to hang. The modular potting system can uniquely serve gardeners by proving pots that allow them to plant in the top, sides and bottom of the pot and moisture is maintained with an internal watering system. These pots connect directly to mechanically automated irrigation device 200 and to each other proving a single, automated irrigation system 100 that provides set and forget ease and the assurance that their plants maintain the right amount of moisture regardless climactic conditions.

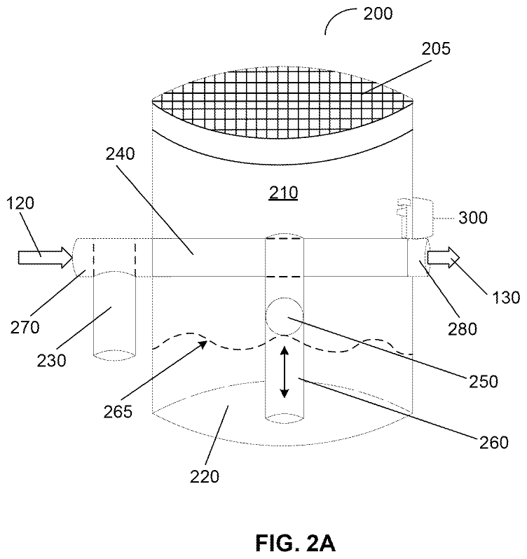

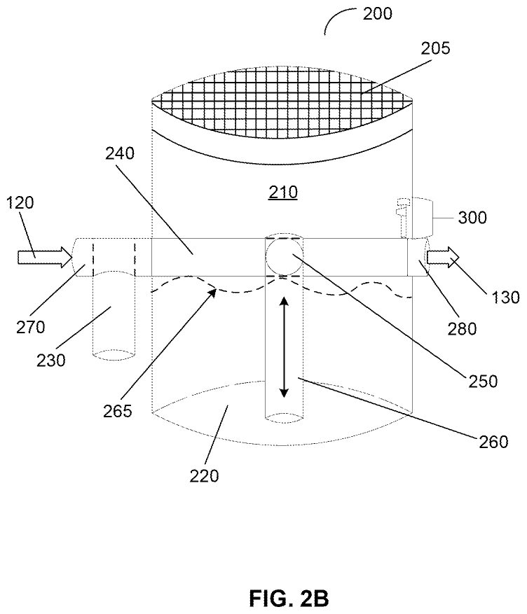

FIG. 2A-2B illustrate a mechanically automated irrigation device 200 in different positions, according to an embodiment. Mechanically automated irrigation device 200 comprises an inlet flow 120 and an outlet flow 130 coupled to a floating valve system 210. As previously mentioned, mechanically automated irrigation device 200 receives liquid through inlet flow 120 and allows liquid exit through outlet flow 130. Further, floating valve system 210 may comprise a liquid container 220 with a strainer mesh top 205, an internal flow duct 240, a floating valve 250, floating valve duct 260, and a feedback array 300. Although only one or two of each component is illustrated, it should be understood that mechanically automated irrigation device 200 may comprise any number of each component, including a plurality of one or more components.

Liquid is supplied from liquid source 110 to mechanically automated irrigation device 200 through inlet flow 120 and may be positioned upstream of at least one outlet flow 130. As described in FIG. 1, inlet flow 120 can be configured with mechanisms to regulate water flow rates, ensuring precise and efficient delivery to designated irrigation channels or pipelines. Further, inlet flow 120 can include an inlet flow valve 270. Positioned strategically upstream, inlet flow valve 270 can govern the flow rate and ensure a controlled and efficient passage of the liquid into floating valve system 210. Examples of inlet flow valves 270 include, without limitation, diaphragm valves and gate valves.

Additionally, mechanically automated irrigation device 200 can include an inlet flow filter 230. Functioning as a protective barrier, inlet flow filter 230 can be designed to intercept and remove solid particles, sediment, and various contaminants present in the liquid (water) before it reaches downstream components such as floating valve system 210. Inlet flow filter 230 can filter common debris like sand, silt, algae, and leaves, which can potentially obstruct or damage floating valve system 210. By ensuring that the liquid flowing through mechanically automated irrigation device 200 remains free from these impurities, inlet flow filter 230 prevents clogs, uneven liquid distribution, and pressure issues that could compromise mechanically automated irrigation device 200. Filtration by inlet flow filter 230 not only enhances the longevity of mechanically automated irrigation device 200 but also contributes to liquid conservation by maintaining the optimal functioning of emitters, ensuring a consistent and efficient distribution of water across the irrigated area. Examples of inlet flow filter 230 include, without limitation, screen filters, disc filters, sand separators, hydrocyclone filters, and media filters.

As described in FIG. 1, liquid exits mechanically automated irrigation device 200 through outlet flow 130 and can be located downstream from inlet flow 120. Further, outlet flow 130 can include an outlet flow valve 280. Positioned strategically downstream, outlet flow valve 280 can govern the flow rate and ensure a controlled and efficient passage of the liquid into irrigation distribution system 140. Examples of inlet flow valves include, without limitation, diaphragm valves and gate valves.

Next, floating valve system 210 can be located between inlet flow 120 and outlet flow 130. As previously mentioned, floating valve system 210 may comprise a liquid container 220 with a strainer mesh top 205, an internal flow duct 240, a floating valve 250, floating valve duct 260, and a feedback array 300. Floating valve system 210 consists of floating valve 250 within floating valve duct 260. As liquid level 265 in liquid container 220 rises or falls, floating valve 250 moves accordingly, activating or blocking the liquid flow. One of the primary functions of floating valve system 210 is to ensure a consistent irrigation according to evaporation levels and liquid level 265 within liquid container 220. When liquid level 265 drops below a predetermined threshold, floating valve 250 opens to allow liquid to flow through internal flow duct 240 into outlet flow 130, and subsequently to irrigation distribution system 140. Conversely, when the liquid level 265 reaches a specified upper limit, floating valve 250 rises, prompting floating valve 250 to close internal flow duct 240 and preventing further liquid flow to outlet low 130. Liquid level 265 may be dependent on the environmental evaporation factors such as temperature, humidity, wind, and solar radiation. The functionality of mechanically automated irrigation device 200 involves regulating the delivery of liquid based on preset parameters, such as time, duration, and frequency through evaporation. The automated process of mechanically automated irrigation device 200 helps to maintain a stable liquid level 265, ensuring a reliable supply for irrigation purposes.

In floating valve system 210, liquid container 220 plays a vital role in regulating liquid levels. Liquid container 220 in floating valve system 210 can be a receptacle designed to hold and store liquid. Liquid container 220 can include various forms, ranging from open reservoirs, cylinders, to closed tanks or cisterns. Further, liquid container 220 may include a strainer mesh top 205 design to allow precipitation and/or evaporation. Liquid container 220 primary function is to provide a reservoir for holding liquid level 265, and it serves as the vessel where the core of floating valve system 210 operates. Constructed from materials such as plastic, concrete, metal, or fiberglass, liquid container 220 is designed to be durable, weather-resistant, and capable of withstanding the demands of its intended environment and/or corrosion. The size and shape of liquid container 220 can vary widely based on the volume of liquid required and the spatial constraints of the installation site.

Internal flow duct 240 extends from inlet flow 120 across liquid container 220 into outlet flow 130. Internal flow duct 240 serves as a conduit within mechanically automated irrigation device 200, designed to facilitate the controlled passage of liquid. Internal flow duct 240 primary function is to guide and direct the flow of liquid within a defined pathway, ensuring efficient transport from inlet flow 120 to outlet flow 130. The intersection of internal flow duct 240 by floating valve duct 260 occurs when these pathways cross or meet at a junction. The design and engineering of the intersections between internal flow duct 240 and floating valve duct 260 allows floating valve 250 to block or allow liquid passage. As an example, internal flow duct 260 may be parallel to an horizontal axis and floating valve duct 260 may be perpendicular to said horizontal axis.

Floating valve duct 260 allows horizontal movement of floating valve 250 based on liquid level 265. The intersection of floating valve duct 260 with internal flow duct 240 occurs at the juncture where controlled water entry or release is necessary. The juncture is shown as in the middle of liquid container 220 but can be at any point and/or height. This intersection facilitates a dynamic interaction between the floating valve 250 and internal flow duct 240, enabling automated adjustments based on liquid levels 265. The floating valve's 250 responsive action ensures a consistent and controlled flow within internal flow duct 240, contributing to efficient water management and preventing issues such as overflow.

Feedback array 300 can be located at the downstream end of internal flow duct 240. Feedback array 300 can be designed to replenish liquid container 220 as liquid flows through internal flow duct 240 towards outlet flow 130. Feedback array 300 can involve control mechanisms that limit or allow liquid feedback into liquid container 220. As liquid enters from inlet flow 120 through internal flow duct 240 and flows towards outlet flow 130, feedback array 300 is activated to replenish the decreasing liquid levels 265 due to evaporation.

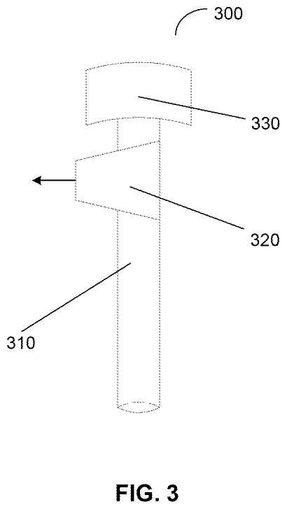

FIG. 3 illustrates a feedback array 300, according to an embodiment. Feedback array 300 comprises a feedback filter 310 configured to filter liquid entering a feedback valve 320, wherein feedback control knob 330 controls feedback valve 320 liquid passage. It should be understood that feedback array 300 may be located internally or externally from floating valve system 210. Although only one or two of each component is illustrated, it should be understood that feedback array 300 may comprise any number of each component, including a plurality of one or more components.

Feedback array 300 can include a feedback filter 310. Functioning as a protective barrier, feedback filter 310 can be designed to intercept and remove solid particles, sediment, and various contaminants present in the liquid (water) before it reaches feedback valve 320. Feedback filter 310 can filter common debris like sand, silt, algae, and leaves, which can potentially obstruct or damage feedback array 300. By ensuring that the liquid flowing through feedback array 300 remains free from these impurities, feedback filter 310 prevents clogs, uneven liquid distribution, and pressure issues that could compromise feedback array 300. Filtration by feedback filter 310 not only enhances the longevity of feedback array 300 but also contributes to liquid conservation by maintaining the optimal functioning of feedback valve 320. Examples feedback filter 310 include, without limitation, screen filters, disc filters, sand separators, hydrocyclone filters, and media filters.

Further, liquid is fed from feedback filter 310 into feedback valve 320. Liquid exits feedback array 300 through feedback valve 320 into liquid container 220. Feedback valve 320 can be positioned strategically downstream and can govern the flow rate and ensure a controlled and efficient passage of the liquid container 220. Examples of inlet flow valves include, without limitation, diaphragm valves and gate valves. Feedback control knob 330 operates through a closed-loop system, incorporating an actuator to maintain a desired liquid feedback volume delivered by feedback valve 320. Feedback control knob 330 can be predefined to setpoints of volume. For example, feedback control knob 330 can be positioned to allow feedback valve 320 feed the liquid container 220 at least half gallon of liquid per hour. The amount of liquid may vary depending in feedback control knob 330 position. This continuous feedback loop ensures that liquid level 265 in liquid container 220 remains within the specified range.

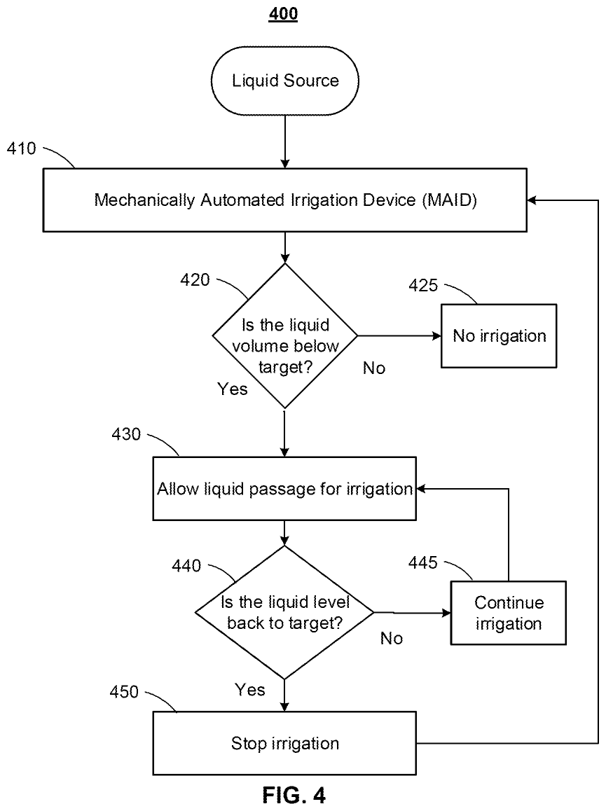

FIG. 4 illustrates a mechanically automatic irrigation process 400, according to an embodiment. Mechanically automatic irrigation process 400 may be implemented with the assistance of mechanically automated irrigation device 200 including automatic irrigation subprocess 410 and irrigation allowance subprocess 430. Ideal liquid volume target 420 may be an indicator for irrigation allowance subprocess 430. Optimum liquid level 440 may be reached through precipitation or liquid feedback through feedback array 300.

In automatic irrigation subprocess 410, mechanically automated irrigation device 200 receives liquid from liquid source 110 routing inlet flow 120 located upstream from at least an outlet flow 130 and transferring volume between them. Volume transfer goes through floating valve system 210, which is coupled to inlet flow 120 and outlet flow 130. If liquid volume target 420 is above the target level, then there is no irrigation 425. Conversely, if volume is below target, liquid flow will proceed to irrigation allowance subprocess 430.

In irrigation allowance subprocess 430, optimum liquid level 440 may be an indicator for irrigation continuance into subprocess 445 which allows liquid to continue passing. Conversely, if the liquid level is back to optimum liquid level 440, then mechanically automatic irrigation process 400 will stop.

Although FIG. 4 shows example blocks of mechanically automatic irrigation process 400, in some implementations, mechanically automatic irrigation process 400 may include additional blocks, fewer blocks, different blocks, or differently arranged blocks than those depicted in FIG. 4. Additionally, or alternatively, two or more of the blocks of mechanically automatic irrigation process 400 may be performed in parallel.

### INDUSTRIAL APPLICABILITY

Typically, non-automated irrigation systems demand manual labor for operation, making them labor-intensive and physically demanding, especially in gardening and small farming operations. On the other hand, automated electrical energy-requiring irrigation systems may require to operate in remote locations, such as small crop field locations, where no supporting infrastructure exists.

Accordingly, a mechanically automated irrigation device 200, which is capable is working solely with mechanical energy and gravity, can offer a variety of benefits. Mechanically automated irrigation device 200 receives liquid through inlet flow 120. Mechanically automated irrigation device 200 is designed to optimize the watering of plants, crops, or landscapes mitigating the need of an electrical energy source because it functions mechanically through measuring the rate of evaporation of liquid (water). Mechanically automated irrigation device 200 comprises a network of components mechanically connected and dependent on the environmental evaporation factors such as temperature, humidity, wind, and solar radiation. The functionality of mechanically automated irrigation device 200 involves regulating the delivery of liquid based on preset parameters, such as time, duration, and frequency through evaporation. Additionally, mechanically automated irrigation device 200 may control irrigation in response to environmental and local conditions, like rainfall or soil moisture levels. Mechanically automated irrigation device 200 automation minimizes water wastage, promotes healthier plant growth, and conserves resources, making it an environmentally responsible solution for maintaining lush and thriving green spaces.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of industrial context or with a particular type of irrigation distribution system 140. Hence, although the present embodiments are, for convenience of explanation, depicted and described as being implemented with irrigation systems, it will be appreciated that it can be implemented for various other types of liquid distribution systems, and in various other environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A mechanically automated irrigation device, comprising:
an inlet flow;
at least an outlet flow located downstream from the inlet flow;
a transfer volume located intermediate the inlet flow and the outlet flow; and
a floating valve system coupled to the inlet flow and the outlet flow, the floating valve system having
a liquid container designed to facilitate evaporation,
an internal flow duct extending from the inlet flow to the outlet flow,
wherein the internal flow duct is positioned at least partially in the transfer volume,
a floating valve duct,
wherein the floating valve duct intersects the internal flow duct to form a junction of the top of the floating valve duct and the internal flow duct,
a floating valve positioned within the floating valve duct,
wherein the floating valve is configured to move vertically within the floating valve duct in response to a volume level in the liquid container,
wherein the floating valve is configured to block the transfer volume when positioned at the junction of the internal flow duct and the floating valve duct, and
a feedback array connected to a downstream portion of the internal flow duct, wherein the feedback array is configured to feed liquid to the liquid container.

2. The mechanically automated irrigation device of claim 1, wherein the liquid container has a strainer mesh top design.

3. The mechanically automated irrigation device of claim 1, further comprising an inlet flow filter.

4. The mechanically automated irrigation device of claim 1, further comprising an inlet flow valve and an outlet flow valve.

5. The mechanically automated irrigation device of claim 1, wherein the inlet flow can come from any water source.

6. The mechanically automated irrigation device of claim 1, wherein the mechanically automated irrigation device is portable.

7. The mechanically automated irrigation device of claim 1, wherein the feedback array comprises:
a feedback filter;
a feedback valve connected to the feedback filter; and
a feedback control knob configured to control an amount of liquid fed to the liquid container through the feedback valve,
wherein the feedback control knob is partially external of the floating valve system.

8. The mechanically automated irrigation device of claim 1, wherein the feedback array is removable.

9. The mechanically automated irrigation device of claim 1, whereon the feedback array is replaceable.

10. The feedback array of claim 7, wherein the feedback control knob can be positioned to allow the feedback valve feed the liquid container at least half gallon of liquid per hour.

11. The feedback array of claim 7, wherein the feedback control knob can be positioned to allow the feedback valve feed the liquid container a quarter gallon of liquid per hour.

12. The mechanically automated irrigation device of claim 1, wherein the mechanically automated irrigation device is made of corrosion resistant material.

13. The mechanically automated irrigation device of claim 1, wherein the mechanically automated irrigation device blocks the volume transfer at a predetermined volume level in the liquid container.

14. The mechanically automated irrigation device of claim 1, wherein the wherein the internal flow duct is parallel to an horizontal axis.

15. The mechanically automated irrigation device of claim 1, wherein the wherein the floating valve duct is perpendicular to an horizontal axis.

16. The mechanically automated irrigation device of claim 1, wherein the volume level in the liquid container changes depending on evaporation rate.

17. The liquid container of claim 5, wherein the design allows precipitation to enter the liquid container.

18. An irrigation system, comprising:
a liquid source;
a mechanically automated irrigation device, comprising:
an inlet flow located upstream from at least an outlet flow;
a transfer volume located intermediate the inlet flow and the outlet flow; and
a floating valve system coupled to the inlet flow and outlet flow, the floating valve system having
a liquid container designed to facilitate evaporation,
an internal flow duct extending from the inlet flow to the outlet flow,
wherein the internal flow duct is positioned at least partially in the transfer volume,
a floating valve duct,
wherein the floating valve duct intersects the internal flow duct to form a junction of the top of the floating valve duct and the internal flow duct,
a floating valve positioned within the floating valve duct,
wherein the floating valve is configured to move vertically within the floating valve duct in response to a volume level in the liquid container,
wherein the floating valve is configured to block the transfer volume when positioned at the junction of the internal flow duct and the floating valve duct,
a feedback array connected to a downstream portion of the internal flow duct, wherein the feedback array is configured to feed liquid to the liquid container, and
an irrigation distributor.

19. The irrigation system of claim 18, wherein the feedback array comprises:
a feedback filter;
a feedback valve connected to the feedback filter; and
a feedback control knob is configured to control the amount of liquid fed to the liquid container through the feedback valve,
wherein the feedback control knob is partially external of the floating valve system.

20. A method for automatically irrigating with a mechanically automated irrigation device, the method comprising:
routing an inlet flow to an outlet flow located downstream;
transferring volume located intermediate the inlet flow and the outlet flow; and
coupling a floating valve system between the inlet flow and outlet flow, the floating valve system having
a liquid container designed to facilitate evaporation,
an internal flow duct extending from the inlet flow to the outlet flow,
wherein the internal flow duct is positioned at least partially in the transfer volume,
a floating valve duct,
wherein the floating valve duct intersects the internal flow duct to form a junction of the top of the floating valve duct and the internal flow duct,
a floating valve positioned within the floating valve duct,
wherein the floating valve is configured to move vertically within the floating valve duct in response to a volume level in the liquid container,
wherein the floating valve is configured to block the transfer volume when positioned at the junction of the internal flow duct and the floating valve duct, and
feeding liquid to the liquid container through a feedback array connected to a downstream portion of the internal flow duct.
